(19) United States
(12) Patent Application Publication
(10) Pub. No.: US 2025/0131709 A1
(43) Pub. Date: Apr. 24, 2025

(54) Method And System For The Automatic Monitoring Of A Liquid Resource Stored In A Lake Using Satellite Imagery

(71) Applicant: Kayrros, Paris (FR)

(72) Inventors: Thibaud Ehret, Champigny Sur Marne (FR); Simon Lajouanie, Paris (FR); Victor LEFRANCOIS, Bordeaux (FR); Carlo De Franchis, Paris (FR)

(73) Assignee: Kayrros, Paris (FR)

(21) Appl. No.: 18/576,957

(22) PCT Filed: Dec. 9, 2021
(86) PCT No.: PCT/IB2021/000865

§ 371 Date: Jan. 5, 2024

(51) Int. Cl. G06T 7/564; G06T 7/13; G06T 7/62

(52) U.S. Cl. CPC G06V 20/13

(57) ABSTRACT

The invention relates to a computer-implemented method of monitoring a liquid resource stored in a lake, comprising the steps of determining a level of the liquid resource in the lake based on a satellite image of the lake and of determining a volume of the liquid resource in the lake based on the determined level and on a volume function of the lake which associates a volume to a given level. Determining said level comprises identifying within the satellite image a contour representative of a shoreline of the liquid resource within the lake and determining a height of the contour based on an elevation model of the lake aligned with the satellite image.

### TECHNICAL FIELD

The invention relates to methods and systems for monitoring a liquid resource stored in a lake using satellite imagery.

### DESCRIPTION OF RELATED ART

Water storage is becoming central to fight more and more frequent droughts. Monitoring of these water resources is very important to know how much water is available at any time and to be able to allocate the optimal amount to each need such as consumption, industrial or farming, without risking a shortage.

Water storage monitoring may also be useful to keep track of underground oil storage. While underground oil storage cannot be observed directly from space, it is still possible to monitor oil exchange from and to an underground storage cavern by looking at the lake(s) associated to the cavern. Originally the cavern is filled with water (it might not necessarily be pure water in practice but here we will assume that it is water) so when oil is added to the cavern, it requires removing the excess water from the cavern. This water is then put into an adjacent artificial lake. Reversely, to remove oil from the cavern water is added back into the cavern. Therefore, in order to track the movement of oil in underground storage cavern the volume of water in the associated lake which is visible from space can be monitored.

Keeping track of the amount of liquid stored in a lake is a difficult task. While the differential of liquid simply corresponds to the difference between the inflow and the outflow, both of them are particularly difficult to estimate due to the many parameters that need to be taken into account and their wide variety (e.g., precipitation, river inflow, evaporation, withdrawals, infiltration, river outflow, etc.). This is why direct measurements of water volume are prioritized in practice.

Traditionally, gauge measurements have been used for onsite measurements. However, these measurements are becoming more and more scarce, either because there is no measurement station available (especially in developing countries) or because the information is not publicly available. This is why space agencies have started programs to encourage the development of remote sensing technologies for a global monitoring of water surfaces.

Some known water storage monitoring methods making use of satellite imagery are based on radar altimetry, which appears not to be suited for small lakes. Other known water storage monitoring methods making use of satellite imagery require radar information which is costly to acquire (for example SAR images of sufficient resolution).

There is consequently a need for an improved method for monitoring a liquid resource stored in a lake based on satellite imagery that addresses these limitations.

### BRIEF DESCRIPTION OF THE INVENTION

For this purpose, the present invention provides a computer-implemented method of monitoring a liquid resource stored in a lake, comprising the steps of determining a level of the liquid resource in the lake based on a satellite image of the lake and of determining a volume of the liquid resource in the lake based on the determined level and on a volume function of the lake which associates a volume to a given level. Determining said level comprises identifying, within the satellite image, a contour representative of a shoreline of the liquid resource within the lake and determining a height of the contour based on an elevation model of the lake aligned with the satellite image.

Certain preferred, but non-limiting aspects of the method are as follows:
the contour comprises a plurality of points and determining the height of the contour comprises determining, based on said elevation model, a height of each point of the contour;
identifying a contour and determining a height of the contour is performed in each of a plurality of regions of interest within the satellite image and the level of the liquid resource in the lake is determined based on the heights determined in the plurality of regions of interest;
identifying a contour in a region of interest comprises selecting the contour having the lowest height amongst multiple contours detected in the region of interest;
it further comprises evaluating a contour and discarding or not the height of a contour identified in a region of interest in the determination of the level of the liquid resource in the lake based on said evaluating;
identifying a contour comprises detecting a line segment;
detecting a line segment comprises performing an Unsupervised Smooth Contour Detection algorithm;
the elevation model of the lake is a previously determined digital elevation model;
the previously determined digital elevation model is an absolute model elaborated from lidar acquisitions or from multi-view stereo acquisitions;
the previously determined digital elevation model is a relative model elaborated based on a first area of the lake, a second area of the lake and a geometric model of the shape of the lake;
it further comprises determining an amount of a liquid energy commodity in storage in an underground cavern associated to the lake, based on the determined volume of the liquid resource in the lake.

### BRIEF DESCRIPTION OF THE DRAWINGS

Other aspects, aims, advantages and features of the invention will better appear upon reading the following detailed description of preferred embodiments thereof, provided as a non-limiting example, and done in reference to the appended drawings, in which:

FIG. 1 is an optical satellite image of a lake showing five regions of interest for shoreline identification;

FIG. 2 shows the shorelines detected in each of the regions of interest of FIG. 1;

FIG. 3 is an optical satellite image of the same lake as FIG. 1 while FIG. 4 is a digital elevation model of the lake in FIG. 3 computed from lidar acquisitions;

FIG. 5 is an optical satellite image of another lake, FIG. 6 shows a mask corresponding to the lake surface when the water is at its lowest level, FIG. 7 shows a mask corresponding to the surface of the filled lake and FIG. 8 shows a digital elevation model estimated using the two masks and a geometric model of the shape of the lake;

FIG. 9 is a block diagram illustrating steps of a method according to a possible embodiment of the invention.

### DETAILED DESCRIPTION OF THE INVENTION

The invention relates to a computer-implemented method of monitoring a liquid resource (such as water or brine) stored in a lake (e.g., an artificial lake such as a reservoir or a pond associated to an oil underground cavern) using a satellite image of the lake.

In an embodiment, the satellite image is an optical satellite image, such as a visible satellite image. For instance, the invention may use PlanetScope images (requiring only the R, G, B bands and not the NIR band which moreover is not always available). PlanetScope has a good enough Ground Sampling Distance (3 m) to be able to work on small lakes and has a daily revisit.

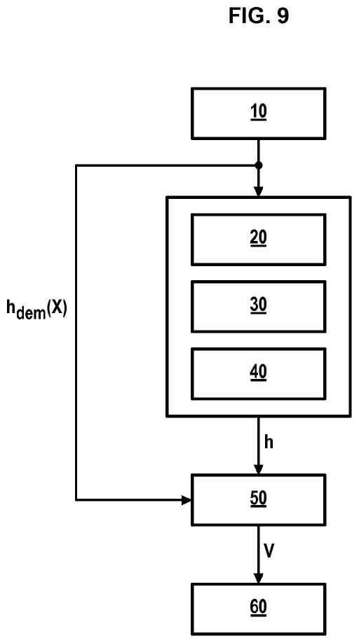

With reference to FIG. 9, this method comprises a step, illustrated by blocks 20, 30 and 40, of determining a level h of the liquid resource in the lake based on a satellite image of the lake and a step, illustrated by block 50, of determining a volume V of the liquid resource in the lake based on the determined level h and on a volume function of the lake which associates a volume to a given level.

In accordance with the invention, the liquid resource level h is estimated by tracking the shoreline of the liquid resource within the lake (i.e., the liquid/land boundary) using the satellite image and the volume V of the liquid resource is derived from this information. More particularly, in the method of the invention determining said level h comprises identifying within the satellite image a contour representative of a shoreline of the liquid resource and determining a height of the contour based on an elevation model h_{dem}(x) of the lake aligned with the satellite image.

The elevation model is a function that provides the altitude of a given position. It provides bathymetry information about the lake (i.e., its 3D shape) so that the height of each point of the identified contour can be derived from its spatial position in the satellite image using the elevation model. Then this height can be associated to the identified contour, based on the heights of the points along the contour, for instance as the median of the heights of the points along the contour. The height associated to the contour is then used as a bathymetric isobath of the top surface of the liquid resource in the lake, said isobath corresponding to the level h of the liquid resource in the lake. In practice the elevation model can be represented as a reference image aligned with the satellite image where a pixel contains the altitude of the point instead of the colour (a rasterized version of the continuous elevation function). This image can be at the same resolution as the satellite image or with a better resolution and thus providing a subpixel accuracy.

In a preferred embodiment which improves the reliability of the level h determination, identifying a contour and determining a height of the contour is performed in each of a plurality of regions of interest within the satellite image. Then, the level of the liquid resource in the lake is determined based on the heights of the contours in the plurality of regions of interest, for instance as the median of the heights of the contours in the plurality of regions of interest.

A possible embodiment of the step of determining the level h of the liquid resource in the lake is as follows. As illustrated by block 20 in FIG. 9, pre-processing operations are performed which comprise detecting whether clouds are present in a region of interest of the satellite image and discarding the region of interest if it is contaminated by clouds. Indeed, clouds block the visibility in R, G, B bands making it difficult to make accurate estimations. These pre-processing operations may further comprise assessing the quality of the satellite image and discarding a low-quality image, as for instance proposed by Jérémy Anger, Carlo de Franchis, and Gabriele Facciolo in “Assessing the Sharpness of Satellite Images: Study of the PlanetScope Constellation,” IGARSS 2019-2019 IEEE International Geoscience and Remote Sensing Symposium. IEEE, 2019, pp. 389-392. The pre-processing operations may further comprise aligning the satellite image with the elevation model and, if necessary, resampling the elevation model at the resolution of the satellite image.

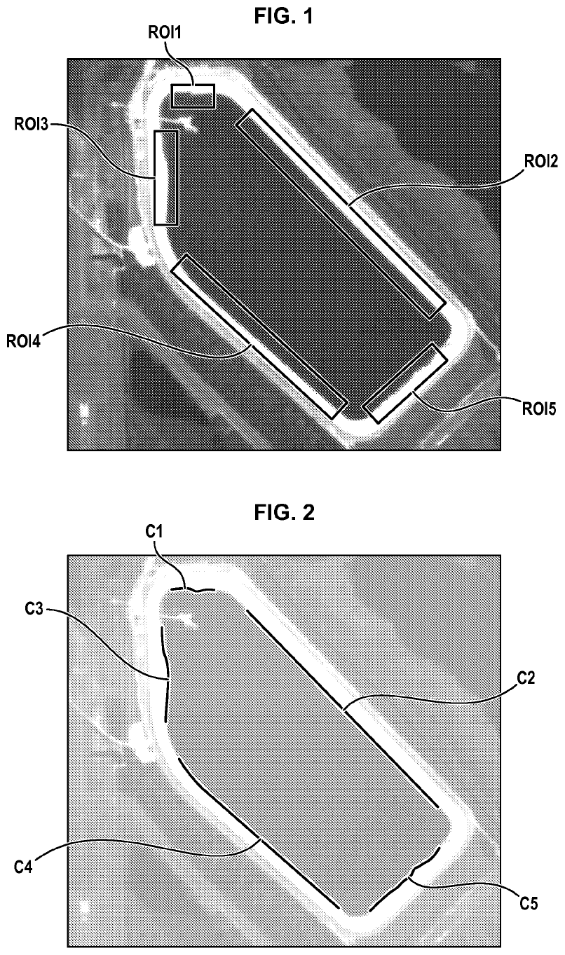

As illustrated by block 30 in FIG. 9, identifying a contour representative of a shoreline of the liquid resource and determining a height of the contour is performed in each of a plurality of regions of interest within the satellite image. The regions of interest are preferably cloud free regions not discarded by the pre-processing operations. In a preferred embodiment, the regions of interest are large straight regions to help for the 30 quality of the shoreline detection as it will be seen later. In practice, the regions of interest are located at each different border of the lake. A mask for each of these regions of interest can be manually annotated, this being necessary only once per lake. In this respect, FIG. 1 shows five such regions of interest RO1-RO5 highlighted on a satellite image of a lake.

Identifying a contour within a region of interest may comprise detecting a line segment in the region of interest. Line segment detection methods are very precise with subpixel detection and are robust to degradation (e.g., noise). In a preferred embodiment, detecting a line segment comprises performing an Unsupervised Smooth Contour Detection algorithm, as for instance described by Rafael Grompone von Gioi and Gregory Randall in “Unsupervised Smooth Contour Detection,” Image Processing On Line, vol. 6, pp. 233-267, 2016. In accordance with such an algorithm, first the high frequencies of the image are extracted by difference of Gaussians. Then, using an arc operator, the region of the image where the values of the pixel on one side are much larger than the ones on the other side are found. A contour is defined as such a region. Once such a contour has been estimated, the probability of appearance of this contour in noise is computed. When the probability is low enough, the contour is said to be detected. In this respect, FIG. 2 shows five contours C1-C5 each automatically detected in the satellite image of the lake in one of the regions of interest RO1-RO5 of FIG. 1.

As the liquid resource is not pure water, it might leave temporary marks after a change of volume. In that case, both the past and the current shorelines may be detected. Therefore, in a possible embodiment of the invention, identifying a contour in a region of interest may comprise selecting the contour having the lowest height amongst multiple contours detected in the region of interest. Indeed, wrong shoreline detections are possible only above the current liquid resource level so that the accurate shoreline is the one at the lowest height. In accordance with this embodiment, a single contour, corresponding to the most probable shoreline in that it is the lowest according to the elevation model, is identified and associated to a region of interest.

In another embodiment, which may for instance be implemented before the above-described height-based selection, a validity assessment of a contour detected in a region of interest may be implemented. This validity assessment may consist in evaluating a contour, for instance by checking a condition on the straightness (for example, the average curvature of the contour or a coefficient derived from a linear regression on the contour) and/or the length of the detected contour, and in discarding or not the contour based on the result of said evaluating (for instance a contour is discarded when it is evaluated as not sufficiently straight and/or long). Indeed, each region of interest is preferentially selected so as to be a long straight side of the lake so that the shoreline is expected to be long, ideally the size of the entire region, and straight (since an artificial lake is a man-made structure, it can reasonably be assumed that the banks are flat and that therefore the liquid follows a line).

As explained above, once a contour is identified in a region of interest, a height can be associated thereto based on the heights of the points along the contour, for instance as the median of the heights of the points along the contour. As illustrated by block 40 in FIG. 9, the heights of the contours identified in all the regions of interest (with those not having passed the validity assessment being potentially discarded) may be analysed in order to discard unreliable height determinations. For example, contours with a high height variance (i.e., most of the points of the contour do not have the same height) may be discarded. Contours which height is disparate from the others may also be discarded. Such unreliable height determinations may for instance result from an unperfect cloud detection. Then, the level of the liquid resource in the lake is determined based on the non-discarded heights of the contours in the plurality of regions of interest (for instance as the median of these valid heights).

As discussed above and illustrated by block 50, the method further comprises a step of determining a volume V of the liquid resource in the lake based on the determined level h and on a volume function of the lake which associates a volume to a given level. Considering that the elevation model h_{dem}(x) is set to infinity outside the studied area and represents within the studied area the altitude of the bottom of the lake at a pixel x, this volume function ƒ_{n→V} can be expressed as an integral function given by ƒ_{n→V}(h)=Σₓ max(h−h_{dem}(x), 0) with h−h_{dem}(x)>0 at those positions x where the liquid resource level is above the bottom of the lake and h−h_{dem}(x)<0 at those positions x where the bottom of the lake is above the liquid resource level (i.e., the banks of the lake which are not submerged at the time of acquiring the satellite image).

In order to estimate the elevation model, the method according to the invention comprises a calibration step illustrated by block 10 in FIG. 9. This calibration step may estimate an absolute elevation model or a relative elevation model.

Estimating an absolute elevation model makes use of remote sensing acquisitions preferentially performed when the lake is empty. Indeed, an acquisition made while the lake is not empty only provides information on the regions that are not submerged at that time. However, this information can still be sufficient if the lake is empty enough.

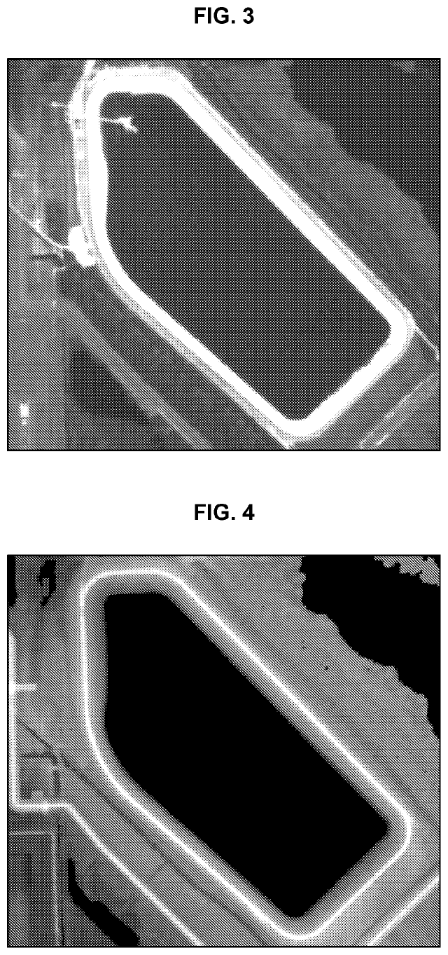

The simplest way to estimate an accurate elevation model is to use lidar acquisitions. A lidar is a tool used to measure distances by illuminating a target using a laser and measuring the time of flight for the laser pulse to get to the target and come back. In practice this tool is put on a plane that flies above the studied area and measures the distance to many points on the ground. Since the height of flight of the plane is known with accuracy, this process gives an accurate altitude for most points targeted. All measurements acquired that way make then a 3d point cloud. Creating a digital elevation model (DEM) from the lidar information simply requires projecting, and if necessary, resampling and interpolating the lidar information into a 2d map at the corresponding spatial resolution. In this respect, FIG. 3 shows an optical satellite image of the same lake as FIG. 1 while FIG. 4 shows a digital elevation model of the lake in FIG. 3 computed from lidar acquisitions.

Another option to estimate an absolute elevation model is to perform a 3D reconstruction of the lake using a multi-view stereo acquisition. Some satellites, like Pleiades, WorldView or SkySat, can be tasked to perform acquisitions of such stereo pairs. The 3D reconstruction is then performed using a tool such as the Satellite Stereo Pipeline described by Carlo de Franchis, Enric Meinhardt-Llopis, Julien Michel, Jean-Michel Morel and Gabriele Facciolo in “An automatic and modular stereo pipeline for pushbroom images” ISPRS Annals of the Photogrammetry, Remote Sensing and Spatial Information Sciences, Zurich, 2014, vol. II. As for lidar, the reconstruction yields a 3d point cloud that then needs to be projected using the camera Rational polynomial coefficients.

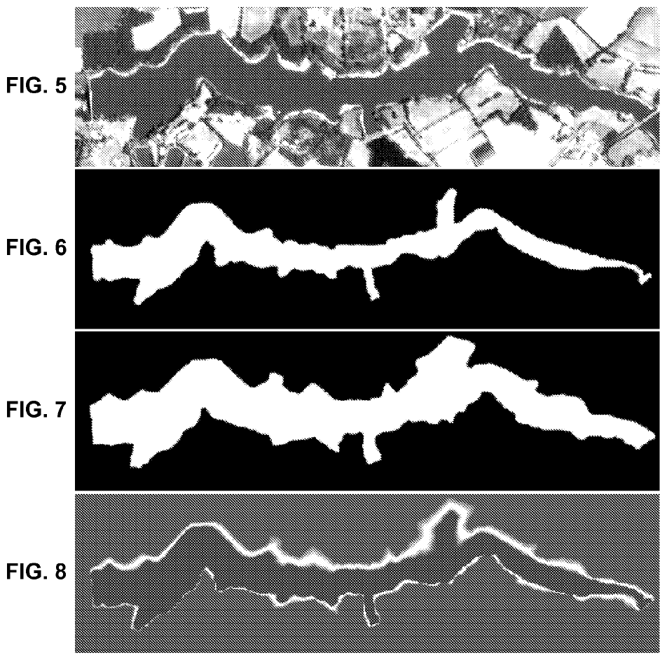

When both lidar and 3D reconstruction are unavailable, a relative elevation model can still be estimated thanks to manual annotation. In that case, absolute volume estimations are only possible using external information such as the maximum volume of the lake. In order to estimate such a relative elevation model, a mask of a first area of the lake (such as its minimum area corresponding to the minimum height of the liquid resource) and a mask of a second area of the lake (such as its maximum area corresponding to the maximum height of the liquid resource) are determined. An elevation model spanned by these two areas can then be determined, using a geometric model of the shape of the lake. In this respect, FIG. 5 is an optical satellite image of a lake, FIG. 6 shows a mask corresponding to the lake surface when the liquid resource is at its minimum height, FIG. 7 shows a mask corresponding to the surface of the filled lake and FIG. 8 shows a digital elevation model estimated using the two masks and a geometric model of the shape of the lake.

For instance, taking the assumption that the lake has the shape of a truncated cone, the relative volume V associated to the lake is then

$$V = \frac{{1}_{} + {2}_{} + \sqrt{{1}_{} {2}_{}}}{3} h ,$$

where [symbol] ₁ and [symbol] ₂ are the minimum area and the maximum area respectively and h is the relative height parameter. Since [symbol] ₁ and [symbol] ₂ are given by the manual annotation, h can be derived from external information such as the maximum volume of the lake. When no external data is available, h is set to 1 and relative height and volumes are computed.

As illustrated by block 60 in FIG. 9, one or more postprocessing operations may be performed to remove one or more sources of external modification of the estimated volume. These post processing operations are preferably performed when the information looked for is not the actual volume of water inside the lake but the volume transfer with a storage cavern.

One such possible source of external modification is precipitation. Given that the lakes are generally artificial, they are usually limited by banks so it can be assumed that the only source of difference is the rain that falls directly into the lake. Given the maximum area of the lake [symbol] ₘₐₓ and weather reports which give the amount of precipitation r (t) at a given time t, the difference of volume due to precipitation between the instants t₁ and t₂ is given by ΔV= [symbol] ₘₐₓ ƒₜ_{₁}^{t}^{₂}r(t)dt.

Another possible source of external modification is evaporation. While precipitation unwantedly increases the volume of water inside the lake, evaporation unwantedly decreases this volume. Estimating evaporation is trickier than precipitation since it is not directly given by the weather report. For that, the simplified De Bruin model for evaporation in open water surfaces can be used:

$$E = \frac{α}{α - 1} \frac{γ}{m + γ} f ( {u}_{2} ) ( 1 - {r}_{h} ) {e}_{s ,}$$

where E is the evaporation, α is the Priestley-Taylor constant, rₕ is the relative humidity, eₛ is the saturated vapor pressure,

$$γ = \frac{0.0016286 P}{{λ}_{v}}$$

with P the pressure, λᵥ is the latent heat of water vaporization, ƒ(u₂) is the wind function at 2 meters and m is approximated by

$$m = \frac{5336}{{T}_{a}^{2}} exp 21.07 - \frac{5336}{{T}_{a}}$$

with Tₐ being the air temperature.

Finally, the difference of water that is not caused by oil transfer is ΔV= [symbol] ₘₐₓ∫ₜ_{₁}^{t}^{₂}r(t)dt−∫ₜ_{₁}^{t}^{₂}E(t)dt.

It will be appreciated that the invention provides an automatic water volume estimation for lakes and reservoirs, based on an accurate and robust shoreline detection. It is able to produce accurate estimations, even on lakes that are too small (namely smaller than 1 km²) for altimetry-based methods, and only requires visible information. It is thus particularly adapted to the PlanetScope constellation although it can be used with any satellite with visible bands.

In a preferred embodiment, the method further comprises determining an amount of a liquid energy commodity (such as oil) in storage in an underground cavern associated to the lake, based on the determined volume V of the liquid resource in the lake. Indeed, the volume V of the liquid resource is directly correlated to the underground volume exchange.

In an alternate embodiment, the invention relates to a computer-implemented method of monitoring a liquid resource stored in a lake, comprising the steps of determining an area of the liquid resource in the lake based on a satellite image of the lake and of determining a volume of the liquid resource in the lake based on the determined area and on a volume function of the lake which associates a volume to a given area.

In this alternate embodiment, determining the area of the liquid resource in the lake based on the satellite image comprises calculating a multispectral water index and detecting the liquid resource when the multispectral water index is above a threshold. Then, by combining the information of where the liquid resource is in the image and the location of the lake, the current area of the lake can be determined.

The multispectral water index may be a Normalized Difference Water Index (NDWI) such as

$$\frac{{I}_{green} - {I}_{nir}}{{I}_{green} + {I}_{nir}} or \frac{{I}_{nir} - {I}_{swir}}{{I}_{nir} + {I}_{swir}} ,$$

where I_{green}>Iₙᵢᵣ and I_{swir} correspond respectively to the green band, the near infrared band and the short-wave infrared band of the satellite image.

Using the elevation model h_{dem}(x) determined as discussed before, an intermediate function [symbol] can be calculated according to [symbol] (h)=Σₓχ_{n>h}_{_{dem}}₍ₓ₎, where χ_{h>h}_{_{dem}}₍ₓ₎=1 if h >h_{dem}(x) and χ_{>h}_{_{dem}}₍ₓ₎=0 otherwise. Then, the volume function of the lake [symbol] which associates a volume to a given area a is given by [symbol] =ƒₙ₋ᵥ ( [symbol] (a)).

The invention is not limited to the methods described above but also extends to a system for monitoring a liquid resource stored in a lake, said system comprising a processor configured to perform the steps of the methods described above. The invention also relates to a computer program product comprising code instructions which, when the program is executed by a computer, cause the computer to carry out the methods described above. The invention further relates to a non-transitory computer medium having stored thereon code instructions which, when executed by a processor, cause the processor to implement the methods described above.

It will be noted that in practice, once the elevation model is known, the volume functions ƒ_{n→V} and [symbol] can be tabulated to save computation time. The tabulation consists in evaluating the functions on a regular sampling of the functions input domains and storing the (input, output) pairs in a look-up table to speed-up future evaluations.

1. A computer-implemented method of monitoring a liquid resource stored in a lake, comprising the steps of determining a level of the liquid resource in the lake based on a satellite image of the lake and of determining a volume of the liquid resource in the lake based on the determined level and on a volume function of the lake which associates a volume to a given level,
wherein determining said level comprises identifying within the satellite image a contour representative of a shoreline of the liquid resource within the lake and determining a height of the contour based on an elevation model of the lake aligned with the satellite image.

2. The computer-implemented method according to claim 1, wherein the contour comprises a plurality of points and wherein determining the height of the contour comprises determining, based on said elevation model, a height of each point of the contour.

3. A The computer-implemented method according to claim 1, wherein identifying a contour and determining a height of the contour is performed in each of a plurality of regions of interest within the satellite image and wherein the level of the liquid resource in the lake is determined based on the heights determined in the plurality of regions of interest.

4. The computer-implemented method according to claim 3, wherein identifying a contour in a region of interest comprises selecting the contour having the lowest height amongst multiple contours detected in the region of interest.

5. A The computer-implemented method according to claim 3, further comprising evaluating a contour and discarding or not the height of a contour identified in a region of interest in the determination of the level of the liquid resource in the lake based on said evaluating.

6. The computer-implemented method according to of claim 1, wherein identifying a contour comprises detecting a line segment.

7. The computer-implemented method according to claim 6, wherein detecting a line segment comprises performing an Unsupervised Smooth Contour Detection algorithm.

8. The computer-implemented method according to claim 1, wherein the elevation model of the lake is a previously determined digital elevation model.

9. The computer-implemented method according to claim 8, wherein the previously determined digital elevation model is an absolute model elaborated from lidar acquisitions or from multi-view stereo acquisitions.

10. The computer-implemented method according to claim 8, wherein the previously determined digital elevation model is a relative model elaborated based on a first area of the lake, a second area of the lake and a geometric model of the shape of the lake.

11. The computer-implemented method according to claim 1, further comprising determining an amount of a liquid energy commodity in storage in an underground cavern associated to the lake, based on the determined volume of the liquid resource in the lake.

12. A non-transitory computer medium having stored thereon code instructions that, when executed by a processor, cause the processor to implement the steps of the method according to claim 1.

13. A system for monitoring a liquid resource stored in a lake, comprising a processor configured to perform the steps of the method according to claim 1.
